(19) United States
(12) Patent Application Publication
(10) Pub. No.: US 2008/0013940 A1
(43) Pub. Date: Jan. 17, 2008

(54) Method, system, and medium for classifying category of photo

(75) Inventors: Yong Ju Jung, Seo-gu (KR); Sang Kyun Kim, Yongin-Si (KR); Ji Yeun Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/605,281

(22) Filed: Nov. 29, 2006

(30) Foreign Application Priority Data
Jul. 11, 2006 (KR) 10-2006-0064760

(51) Int. Cl. G03B 17/00

(52) U.S. Cl. 396/78

(57) ABSTRACT

A photo category classification method including dividing a region of a photo based on content of the photo and extracting a visual feature from the segmented region of the photo, modeling at least one local semantic concept included in the photo according to the extracted visual feature, acquiring a posterior probability value from confidence values acquired from the modeling of the at least one local semantic concept by normalization using regression analysis, modeling a global semantic concept included in the photo by using the posterior probability value of the at least one local semantic concept; and removing classification noise from a confidence value acquired from the modeling the global semantic concept.

### CROSS-REFERENCE TO RELATED APPLICATIONS

This application claims the benefit of Korean Patent Application No. 10-2006-0064760, filed on Jul. 11, 2006, in the Korean Intellectual Property Office, the disclosure of which is incorporated herein by reference.

### BACKGROUND OF THE INVENTION

1. Field of the Invention

The present invention relates to a method and system for classifying a category of a photo. More particularly, to a photo category classification method and system analyzing content of a photo, segmenting a region of the photo based on the analyzed content, classifying a category of the photo by extracting a visual feature from the segmented region, and removing classification noise included in a confidence value with respect to the classified category of the photo.

2. Description of the Related Art

FIG. 1 illustrates a conventional photo category classification method. As shown in FIG. 1, the method includes inputting image data for category based clustering (operation 110), segmenting region of the image by receiving a photographic region template (operation 120), modeling a local semantic concept included in the photo from the segmented region (operations 130 through 150), merging a semantic concept of each region according to confidence of the local semantic concept measured from the modeling (operation 160), modeling a global semantic concept included in the photo by using a final local semantic concept determined by the global concept detectors (operation 170), and deciding at least one category concept included in the inputted photo according to confidence of the global semantic concept measured from the modeling (operation 180).

FIG. 2 is a diagram illustrating an example of a conventional regionally segmented template.

However, in the conventional photo category classification method, an inputted photo is segmented into 10 sub-regions according to regionally segmented template 201 through 210 shown in FIG. 2 and a visual feature is extracted from each of the 10 sub-regions. As described above, in the conventional photo category classification method, since the photo is segmented into the 10 sub-regions, without considering content of the photo and the visual feature is extracted from each of the 10 sub-regions, a large amount of time is consumed.

As described above, since it currently takes 4 seconds per one page to classify a photo based on a category on a 3.0 GHz Pentium computer for the conventional photo category classification method, there are many restrictions on a photo management application classifying the category of the photo.

Also, since a method of using various situation information included in a photo is not utilized in the conventional photo category classification method, precision of classifying the category of the photo is low.

### SUMMARY OF THE INVENTION

According, it is an aspect of the present invention to provide a photo category classification method and system capable of reducing an amount of time for classifying a category of a photo, while minimally deteriorating category classification performance.

It is another aspect of the present invention to provide a photo category classification method and system improving classification performance through removing classification noise by using various situation information included in a photo.

Additional aspects and/or advantages of the invention will be set forth in part in the description which follows and, in part, will be apparent from the description, or may be learned by practice of the invention.

The foregoing and/or other aspects of the present invention are achieved by providing a photo category classification method including segmenting a region of a photo based on content of the photo and extracting a visual feature from the segmented region of the photo, modeling at least one local semantic concept included in the photo according to the extracted visual feature, acquiring a posterior probability value from confidence values acquired from the modeling of the at least one local semantic concept by normalization using regression analysis, modeling a global semantic concept included in the photo by using the posterior probability value of the at least one local semantic concept, and removing classification noise from a confidence value acquired from the modeling the global semantic concept.

It is yet another aspect of the present invention to provide a photo category classification system including a preprocessor performing preprocessing operations of analyzing content of an inputted photo, adaptively segmenting a region of the photo based on the analyzed content of the photo, and extracting a visual feature from the segmented region of the photo, a classifier classifying a category of the inputted photo depending on the visual feature extracted by the preprocessor, and a post-processor performing post-processing operations of estimating classification noise of a confidence value of the category of the photo classified by the classifier and removing the estimated classification noise.

### BRIEF DESCRIPTION OF THE DRAWINGS

These above and/or other aspects and advantages of the present invention will become apparent and more readily appreciated from the following detailed description of the embodiments, taken in conjunction with the accompanying drawings of which:

FIG. 1 is a diagram illustrating a concept of a conventional photo category division algorithm using a regionally segmented template;

FIG. 2 is a diagram illustrating an example of a conventional regionally segmented template;

FIG. 3 is a diagram illustrating an example of relationships between local concepts and global concepts according to an embodiment of the present invention;

FIG. 4 is a diagram illustrating a configuration of a photo category classification system according to an embodiment of the present invention;

FIG. 5 is a diagram illustrating an example of selecting an adaptive region template based on photo content, according to an embodiment of the present invention;

FIG. 6 is a diagram illustrating an example of an entropy value with respect to a segmented region of a photo according to an embodiment of the present invention;

FIG. 7 is a diagram illustrating an example of a model of classification noise;

FIG. 8 is a flowchart illustrating a photo category classification method according to another embodiment of the present invention;

FIG. 9 is a flowchart illustrating a process of adaptively segmenting a region based on content of a photo, according to an embodiment of the present invention;

FIG. 10 is a flowchart illustrating a process of removing noise by estimating noise probability function based on a histogram according to an embodiment of the present invention;

FIG. 11 is a diagram illustrating a result of a performance test of the conventional photo category classification method;

FIGS. 12 and 13 are diagrams illustrating a result of a performance test of the photo category classification method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

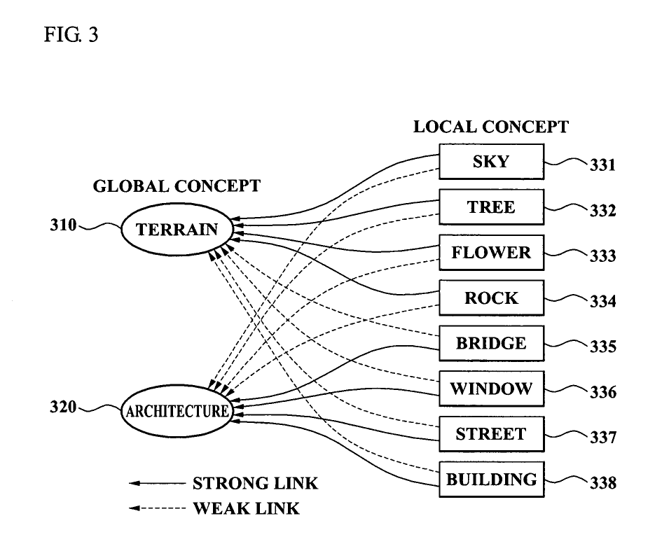

FIG. 3 is a diagram illustrating an example of relationships between local concepts and global concepts according to an embodiment of the present invention. As shown in FIG. 3, a global concept is a high-level category concept such as terrain 310 and architecture 320, and a local concept is a low-level category concept such as sky 331, tree 332, flower 333, rock 334, bridge 335, window 336, street 337, and building 338. A strong link is formed between the terrain 310 and the sky 331, the tree 332, the flower 333, and the rock 334, which belong to natural terrain. A weak link is formed between the terrain 310 and the bridge 335, the window 336, the street 337, and the building 338, which belong to artificial architecture. A strong link is formed between the architecture 320 and the bridge 335, the window 336, the street 337, and the building 338, which belong to artificial architecture. A weak link is formed between the architecture 320 and the sky 331, the tree 332, the flower 333, and the rock 334, which belong to natural terrain.

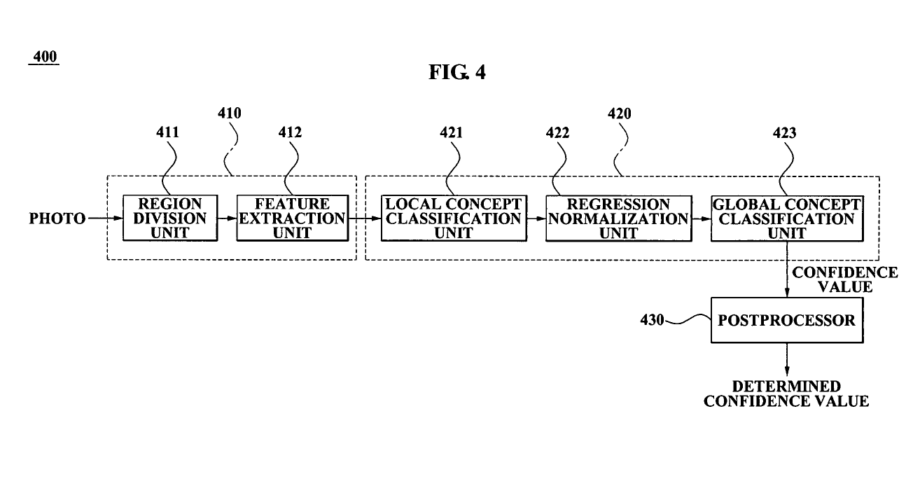

FIG. 4 is a diagram illustrating a configuration of a photo category classification system according to an embodiment of the present invention. As shown in FIG. 4, the photo category classification system 400 comprises a preprocessor 410, a classifier 420, and a postprocessor 430.

The preprocessor 410 comprises a region division unit 411 and a feature extraction unit 412 to perform preprocessing operations of adaptively segmenting a region of an inputted photo through analyzing content of the photo and extracting a visual feature from the segmented region of the photo.

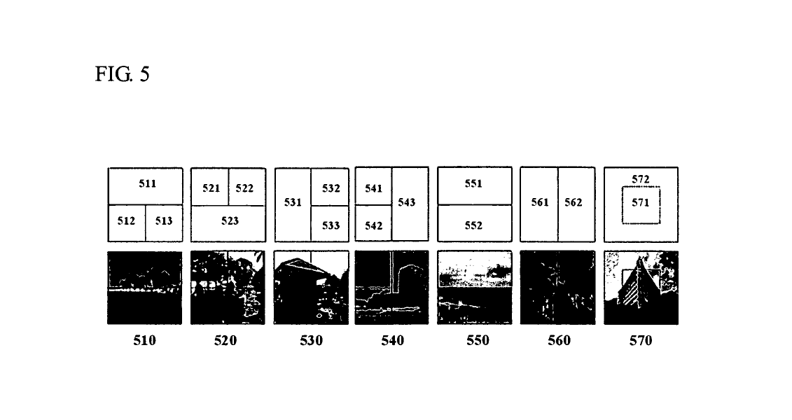

The region division unit 411 analyzes the content of the inputted photo and adaptively segments the region of the photo based on the analyzed content of the photo, as shown in FIG. 5. FIG. 5 is a diagram illustrating an example of selecting an adaptive region template based on photo content, according to an embodiment of the present invention.

As shown in FIG. 5, a region template selected when an inputted photo 510 is segmented horizontally and a lower part of the segmented horizontally photo is segmented vertically, as a result of analyzing content of the inputted photo, is shown. In a photo 520, a region template selected when an inputted photo is segmented horizontally and an upper part of the segmented horizontally photo 520 is segmented vertically, as a result of analyzing content of the inputted photo, is shown. In a photo 530, a region template selected when the photo 530 is segmented vertically and a right part of the segmented vertically photo is segmented horizontally, as a result of analyzing content of the inputted photo, is shown. In a photo 540, a region template selected when the inputted photo 540 is segmented vertically and a left part of the segmented vertically photo 540 is segmented horizontally, as a result of analyzing content of the inputted photo 540, is shown. In a photo 550, a region template selected when the inputted photo 550 is segmented horizontally, as a result of analyzing content of the inputted photo 550, is shown. In a photo 560, a region template selected when the inputted photo 560 is segmented vertically, as a result of analyzing content of the inputted photo 560, is shown. In a photo 570, a region template selected when a central region of the inputted photo 570 is segmented, as a result of analyzing content of the inputted photo 570, is shown.

The region division unit 411 calculates a dominant edge and an entropy differential through analyzing the content of the inputted photo, and adaptively segments the region of the inputted photo based on the calculated dominant edge and the entropy differential.

The region division unit 411 also calculates edge elements for each possible division direction through analyzing the content of the inputted photo, and segments the region of the photo in the direction of a dominant edge through analyzing the calculated edge element. Namely, the region division unit 411 calculates the edge elements for each possible division directions by analyzing the content of the inputted photo and segments the region of the photo in the direction of the dominant edge when a maximum edge element of the calculated edge element is greater than a first threshold and a difference of the calculated edge elements is greater than a second threshold.

When the content of the inputted photo is analyzed, the edge elements for each of the possible division directions are analyzed, and the region of the photo is segmented in the direction of the dominant edge will be described as follows. The region division unit 411 compares a horizontal edge element and a vertical edge element, calculated as the edge element for each of the possible division directions, and horizontally segments the region of the photo when the maximum edge element is the horizontal edge element, the horizontal edge element is greater than the first threshold, and a difference between the horizontal edge element and the vertical edge element is greater than the second threshold. Also, the region division unit 411 vertically segments the region of the photo when the maximum edge element is the vertical edge element, the vertical edge element is greater than the first threshold, and a difference between the vertical edge element and the horizontal edge element is greater than the second threshold.

Conversely, in a case in which the content of the inputted photo is analyzed, the edge elements for each of the possible division directions are analyzed, and the region of the photo is segmented by calculating entropy when the direction of the dominant edge is not determined will be described as follows. When the dominant edge direction is not determined as a result of the analysis of the edge element for each of the calculated possible division directions, the region division unit 411 calculates entropy for each expected division regions of the inputted photo and segments the region of the photo in the direction where a difference between calculated entropy values is the greatest.

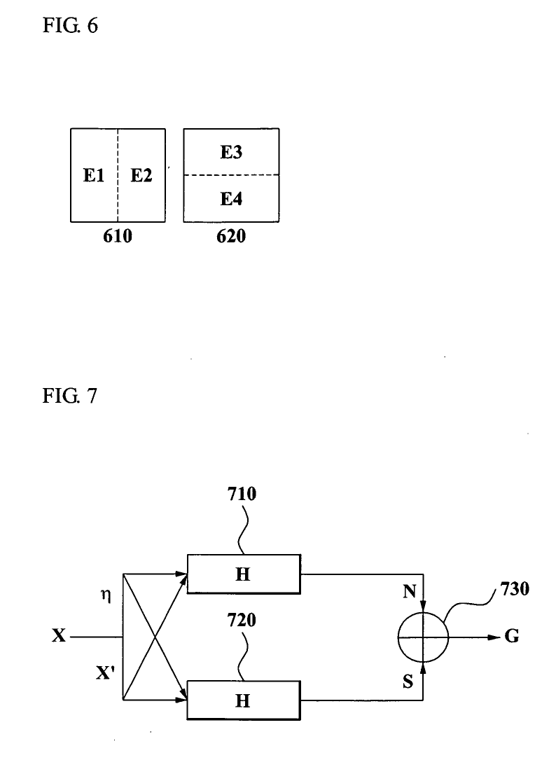

FIG. 6 is a diagram illustrating an example of an entropy value with respect to a segmented region of a photo according to an embodiment of the present invention.

Namely, when an expected division direction is a vertical direction as shown in 610 of FIG. 6 or a horizontal direction as shown in a segmented template 620 of FIG. 6, the region division unit 411 segments the region of the photo into a first region and a second region when dividing the region of the photo in a vertical direction and segments the region of the photo into a third region and a fourth region when dividing the region of the photo in a horizontal direction. The region division unit 411 calculates entropy values E1 through E4 of the first through fourth regions, respectively, and calculates a difference between the entropy value of the first region and the entropy value of the second region (i.e., D1=E1−E2) and a difference between the entropy value of the third region and the entropy value of the fourth region (i.e., D2=E3−E4). The region division unit 411 segments the region of the photo in a vertical direction when the difference D1 between the entropy value of the first region and the entropy value of the second region is greater than the difference D2 between the entropy value of the third region and the entropy value of the fourth region. Namely, since a region of a part whose difference between the entropy values is greater has a greater change in the photo content, the region of the photo is segmented in the direction where the content change is greater.

For example, as shown in FIG. 5, when the photo 510 is inputted, the region division unit 411 analyzes content of the inputted photo 510, segments an entirety of the photo 510 in a horizontal direction depending on a calculated possible division direction edge element or an entropy difference, analyzes the photo 510 segmented horizontally, and segments a lower part of the segmented photo 510 in a vertical direction. Accordingly, the photo 510 is segmented by the region division unit 411, into three regions 511, 512, and 513.

When the photo 520 is inputted, the region division unit 411 analyzes the content of the inputted photo 520, segments an entirety of the photo 520 in a horizontal direction depending on a calculated possible division direction edge element or an entropy difference, analyzes the photo 520 segmented horizontally, and segments an upper part of the segmented photo 520 in a vertical direction. Accordingly, the photo 520 is segmented by the region division unit 411, into three regions 521, 522, and 523.

When the photo 530 is inputted, the region division unit 411 analyzes the content of the inputted photo 530, segments an entirety of the photo in a vertical direction depending on a calculated possible division direction edge element or an entropy difference, analyzes the photo 530 segmented vertically, and segments a right part of the segmented photo 530 in a horizontal direction. Accordingly, the photo 530 is segmented by the region division unit 411, into three regions 531, 532, and 533.

When the photo 540 is inputted, the region division unit 411 analyzes the content of the inputted photo 540, segments an entirety of the photo 540 in a vertical direction depending on a calculated possible division direction edge element or an entropy difference, analyzes the photo 540 segmented vertically, and segments a left part of the segmented photo 540 in a horizontal direction. Accordingly, the photo 540 is segmented by the region division unit 411, into three regions 541, 542, and 543.

When the photo 550 is inputted, the region division unit 411 analyzes the content of the inputted photo 550 and segments an entirety of the photo 550 in a horizontal direction depending on a calculated possible division direction edge element or an entropy difference. Accordingly, the photo 550 is segmented by the region division unit 411, into two regions 551 and 552.

When the photo 560 is inputted, the region division unit 411 analyzes the content of the inputted photo 560 and segments an entirety of the photo 560 in a vertical direction depending on a calculated possible division direction edge element or an entropy difference. Accordingly, the photo 560 is segmented by the region division unit 411, into two regions 561 and 562.

When the photo 570 is inputted, the region division unit 411 analyzes the content of the inputted photo 570 and segments an entirety of the photo 570 into a central region 571 and a peripheral region 572 depending on a calculated possible division direction edge element or an entropy difference. In this case, since the peripheral region 572 is not a rectangle, it is not easy to extract a visual feature. Therefore, the photo 570 is segmented into the central region 571 and an entire region including the central region. Accordingly, the photo 570 is segmented by the region division unit 411, into two regions 571 and 572.

The feature extraction unit 412 extracts a visual feature of each of the segmented regions of the photo. Namely, the feature extraction unit 412 extracts visual features from each of the segmented regions of the photo, such as a color histogram, an edge histogram, a color structure, a color layout, and a homogeneous texture depicter. According to an embodiment of the present invention, the feature extraction unit 412 extracts the visual feature from each of the segmented regions according to a tradeoff between time and precision of a system in a content-based image retrieval field by using various feature combinations. Accordingly, the feature extraction unit 412 extracts the visual feature through the various feature combinations from each of the segmented regions according to a category as defined by the present invention.

In the case of the photo 510, the feature extraction unit 412 extracts a visual feature from each of the regions 511, 512, and 513 segmented by the region division unit 411. In the case of the photo 520, the feature extraction unit 412 extracts a visual feature from each of the regions 521, 522, and 523 segmented by the region division unit 411. In the case of the photo 530, the feature extraction unit 412 extracts a visual feature from each of the regions 531, 532, and 533 segmented by the region division unit 411. In the case of the photo 540, the feature extraction unit 412 extracts a visual feature from each of the regions 541, 542, and 543 segmented by the region division unit 411.

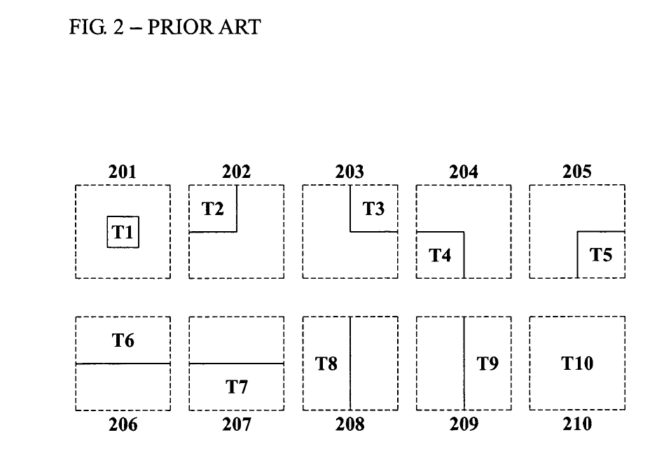

As described above, unlike a conventional photo category classification system unconditionally dividing an inputted photo into at least one region and each region having 10 sub-regions without considering content of the photo as shown in FIG. 2, according to an embodiment of the present invention, the photo category classification system 400 as shown in FIG. 4, for example, segments the region of the photo by considering the content of the photo, thereby relatively reducing a number of regions of the segmented photo and consuming a relatively small amount of time to extract a visual feature from each of the segmented regions.

The classifier 420 comprises a local concept classification unit 421, a regression normalization unit 422, and a global concept classification unit 423 to classify a category of the inputted photo according to the visual feature extracted by the preprocessor 410.

The local concept classification unit 421 analyzes the visual feature extracted by the feature extraction unit 412 and models a local semantic concept included in the photo from the segmented region to classify a local concept. Namely, to model each local semantic concept, the local concept classification unit 421 previously prepares certain learning data to extract visual features, learns via a pattern trainer such as support vector machines (SVM), and classifies a local concept via the pattern learner depending on the visual feature. Accordingly, the local concept classification unit 421 acquires confidence values for each of the local semantic concepts from each region as a result of classifying the local concept via the pattern learner. For example, the confidence value for each of the local concepts (see FIG. 3) may be expressed as 0.4 in the case of cloudy sky, 0.5 in the case of a tree, 1.7 in the case of a flower, −0.3 in the case of a rock, and 0.1 in the case of a street, for example.

The regression normalization unit 422 acquires a posterior probability value by normalizing the confidence values for each of the local concepts classified by the local concept classification unit 421 via regression analysis.

The global concept classification unit 423 classifies a global concept by modeling a global semantic concept that a category concept, included in the photo, through posterior probability values for each of the local semantic concepts acquired by the regression normalization unit 422. Namely, the global concept classification unit 423 classifies global concept models previously learned via the pattern trainer to model the global semantic concept by using a pattern classifier. Accordingly, the global concept classification unit 423 acquires confidence values for each category classified by the pattern classifier. The confidence values for each of the categories may be expressed as −0.3 in the case of architecture, 0.1 in the case of an interior, −0.5 in the case of a night view, 0.7 in the case of terrain, and 1.0 in the case of a human being, for example.

The postprocessor 430 estimates classification noise of a confidence value for the category of the photo, classified by the classifier 420, and performs a postprocessing operation of removing the estimated classification noise. The postprocessor 430 estimates a noise occurrence probability or a category existence probability and outputs a determined confidence value by filtering the confidence value for the category of photo, classified through the classifier 420. The postprocessor 430 clusters a situation by analyzing a plurality of photos, classifies scenes for the photos in the same cluster, calculates a noise probability for each scene category, and updates a confidence value for each scene to reduce the classification noise, by reflecting the calculated noise probability in the confidence value.

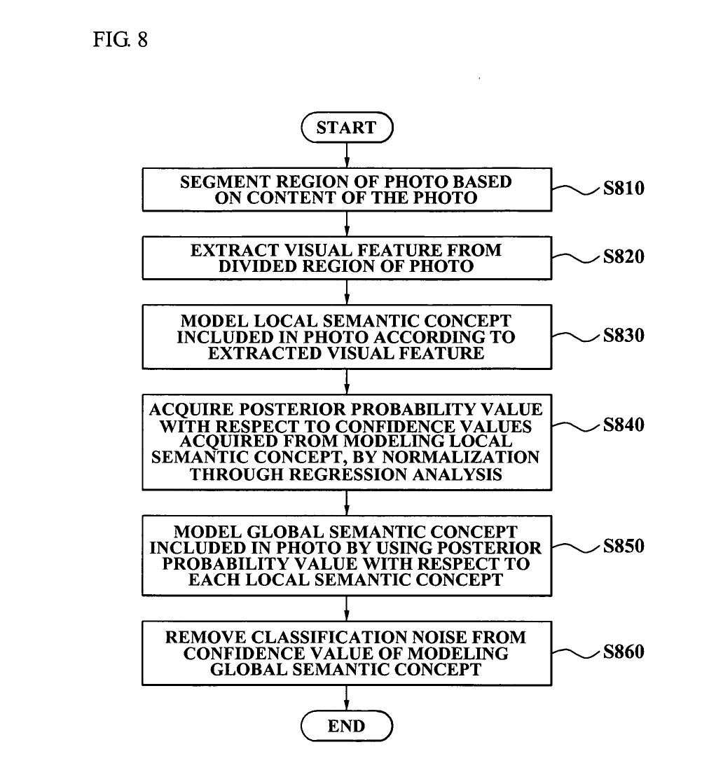

FIG. 7 is a diagram illustrating an example of a model of classification noise. As shown in FIG. 7, it is estimated that noise is added to the classification noise model (a first estimation) and the classification noise model has a property of adding results of classifying by pattern classifiers 710 and 720 by an adder 730 (a second estimation).

x=x′+η (an input+noise)
s=H[x′] (a result value of the pattern classifier with respect to the input)
η=H[n] (a result value of the pattern classifier with respect to the noise)
g=s+n (a final result value of the pattern classifier, including the noise)

ŝᵢ=F_{c}^{ᵢ}[gᵢ]=F_{c}^{ᵢ}[sᵢ+nᵢ]≈F_{c}^{ᵢ}[sᵢ]|

### The result including the noise is an ideal result value acquired through filtering by a filter (F).

To design a noise reduction filter (F) having excellent performance, two conditions as below must be satisfied.

1) F_{c}^{ᵢ}[n_{i]}≈0

2) Other aspects related to a precise classification result are not deteriorated and there is no unfavorable side effect with respect to F_{c}^{ᵢ}[sᵢ]|.

Since an unexpected result value (n) is generated by a noise result, when there is a prior knowledge with respect to a noise probability density function, the unexpected result value (n) is removed by filtering as shown in Equation 1.

ŝᵢ=p(gᵢ)(1−p(nᵢ|cᵢ))| [Equation 1]

### In this case, p(gᵢ)| indicates a posterior probability of a confidence value that is a result of a category classifier of the global concept classifier 423, p(nᵢ|cᵢ)| indicates a noise conditional probability of the category.

In this case, the noise probability may be estimated by various methods as below.
1) Stochastic Noise Reduction Filter
   histogram-based noise probability estimation
   noise probability estimation by posterior probability integration of confidence values
2) Inter-Category Update Rule-Based Filter

As described above, the noise reduction method according to the present invention uses various situation information included in a photo, such as syntactic hints.

Generally, without a prior knowledge with respect to an input signal, it is difficult to distinguish a difference between a signal and noise. Accordingly, a histogram is available for estimating the noise probability density function.

In the present invention, to acquire the histogram, situation-based groups, which are groups of photos whose image information is temporally similar are considered. In this case, to readjust the confidence value that is the result of the category classification, temporal homogeneity in which similar photos exist before and after a corresponding photo is used.

In an embodiment of the present invention, the noise probability is estimated based on a fact that similar categories may exist in photos which are images sequentially photographed by the same user, and the classification noise is removed by the estimated noise probability.

Appearance frequency of each category in on situation group is calculated as Equation 2.

$$( 1 - p ( {n}_{i} \vert {c}_{i} ) ) = p ( {c}_{i} \vert m ) = \frac{{N}_{{c}_{i}}}{N} \qquad [ Equation 2 ]$$

### In this case, N indicates a total number of photos existing in a given situation m, and N_{Ci} indicates appearance frequency of an ith category.

For example, when the same situation-based group including a present photo is formed of 10 photos including 8 photos with respect to a terrain category and 2 photos with respect to an interior category, appearance frequency of the terrain category may be 8/10 and appearance frequency of the interior category may be 2/10.

The postprocessor 430 readjusts the confidence value by using the probability value acquired by the histogram method as shown in Equation 3, thereby removing the noise.

ŝᵢ=p(gᵢ)p(cᵢ|m)| [Equation 3]

For example, when the confidence value of a terrain category is 0.5 and the confidence value of an interior category is 0.8, the postprocessor 430 may readjust the confidence value for each of the categories by multiplying the confidence value 0.5 by the appearance frequency 8/10 of the terrain category and multiplying the confidence value 0.8 of the interior category by the appearance frequency 2/10 of the interior category.

As described above, the photo category classification system 400 reduces a confidence value of a category whose appearance frequency is low from the photos in the same situation-based group, thereby improving the confidence of the photo category classification.

Also, to estimate a more precise probability, the postprocessor 430 may integrate the posterior probability of the confidence value acquired by the classifier as shown in Equation 4.

$$p ( {c}_{i} \vert m ) = \frac{{\prod }_{j = 1}^{N} p ( {g}_{ij} )}{{\sum }_{i = 1}^{C} {\prod }_{j = 1}^{N} p ( {g}_{ij} )} \vert \qquad [ Equation 4 ]$$

In this case, C indicates a total number of categories to be classified, N indicates a total number of photos existing in a given situation m, and gᵢⱼ indicates a confidence value that is a result of ith category from a jth photo, acquired by the pattern classifier.

As described above, when a plurality of photos are analyzed to be images sequentially photographed, the postprocessor 430 estimates through using a fact that similar categories exist, and removes the classification noise of the photo by reflecting the estimated noise probability in the confidence value acquired through the global semantic concept modeling.

According to another embodiment of the present invention, noise is removed by modeling Exchangeable image file (Exif) metadata included in a photo file. Namely, classification noise may be removed based on a probability of belonging to a category, estimated by modeling Exif metadata probability. When the photo is acquired from a digital camera, the Exif metadata comprises various information related to the photo, for example, a flash use and an exposure time.

The postprocessor 430 models a situation probability density function with respect to the Exif metadata acquired by learning many training data, extracts the Exif metadata included in the photo file, calculates a situation probability with respect to the extracted Exif metadata, and removes the classification noise by reflecting the calculated situation probability in a category classification confidence value of the photo file.

For example, noise reduction filtering performed by an interior/exterior classifier by using a flash use (F) and an exposure time (E) as metadata, as shown in Equation 5.

ŝ=p(gᵢ)p(E|cᵢ)p(F|cᵢ) [Equation 5]

As described above, the postprocessor 430 performs the postprocessing operations of estimating the probability of belonging to the category through probability modeling by analyzing the metadata with respect to the photo and removing the classification noise by reflecting the estimated probability in the confidence value acquired by modeling global semantic concepts.

According to yet another embodiment of the present invention, noise reduction is performed by filtering based on an update rule between categories. Namely, the filtering is performed by using a fact that categories having opposite concepts cannot simultaneously exist in one photo, as an estimation method based on a rule using correlation of a category group.

For example, to an interior category, an exterior category such as terrain, waterside, sunset, snowscape, and architecture are the categories having opposite concepts. Namely, since the interior category is opposite to the exterior categories, it is impossible for both to be in the same photo.

Filtering classification noise by using the correlation between the interior category and the exterior category is performed as shown in Equation 6.

$${\hat{s}}_{indoor} = p ( {g}_{indoor} ) ( 1 - p ( {g}_{terrain} ) ) ( 1 - p ( {g}_{waterside} ) ) \cdot ( 1 - p ( {g}_{architecture} ) ) ( 1 - p ( {g}_{sunset} ) ) \\ where 0 < p ( g ) \leq 1 , \\ \{ \begin{matrix} p ( g ) = 1 , & if g > {T}_{1} , \\ p ( g ) = \frac{g}{{T}_{2}} or p ( g ) = \frac{1}{1 + exp ( - Ag + B )} , & if 0 < g < {T}_{2} , \\ p ( g ) = 0 , & if g < 0 ,\end{matrix} \qquad [ Equation 6 ]$$

### In this case, (T1) and (T2) indicate thresholds determined by the photo category classification system 400.

As another example of the categories having opposite concepts, there are a macro category, and other categories excluding the macro category. The postprocessor 430 may filter by distinguishing the macro photo from a result of classified categories by using a fact that a macro photo is incompatible with any other category. Namely, when there are the macro category and the other categories as the result of category classification of the inputted photo, and a confidence value of the macro category is greater than confidence values of the other categories, the postprocessor 430 may perform filtering to remove the other categories.

The postprocessor 430 filters the macro category and the interior category as shown in Equation 7.

$$\begin{matrix} {\hat{s}}_{indoor} = p ( {g}_{indoor} ) ( 1 - p ( {g}_{macro} ) ) \\ p ( {g}_{macro} ) = \{ \begin{matrix}1 , & if macro field is on in Exif \\ 0 , & if macro field is off in Exif\end{matrix}\end{matrix} \vert \qquad [ Equation 7 ]$$

To verify whether the inputted digital photo is a macro photo, the postprocessor 430 uses Exif information including macro information below.

1) a subject distance: generally less than 0.6 m;

2) subject distance ranges 0: unknown, 1: macro, 2: close view, and 3: distance view; and

3) macro information in a maker note.

When the inputted digital photo is a macro photo, the postprocessor 430 determines a probability value of the category to be 1 and determines a probability value of the interior category to be 0. Accordingly, when the inputted digital photo is the macro photo as shown in Equation 7, the postprocessor 430 reflects the probability value of the interior category in a classification confidence value of the inputted digital photo, thereby filtering the confidence value of the interior category opposite to the macro photo category, to be 0.

As described above, when confidence values of mutually opposite categories exist as a result of analyzing the confidence values acquired by global semantic concepts modeling, the postprocessor 430 performs a postprocessing operation of removing a category whose confidence value is low.

Accordingly, the photo category classification system 400 classifies the category of the inputted photo and removes the classification noise from the confidence value of the classified category, thereby providing a more precise category classification result.

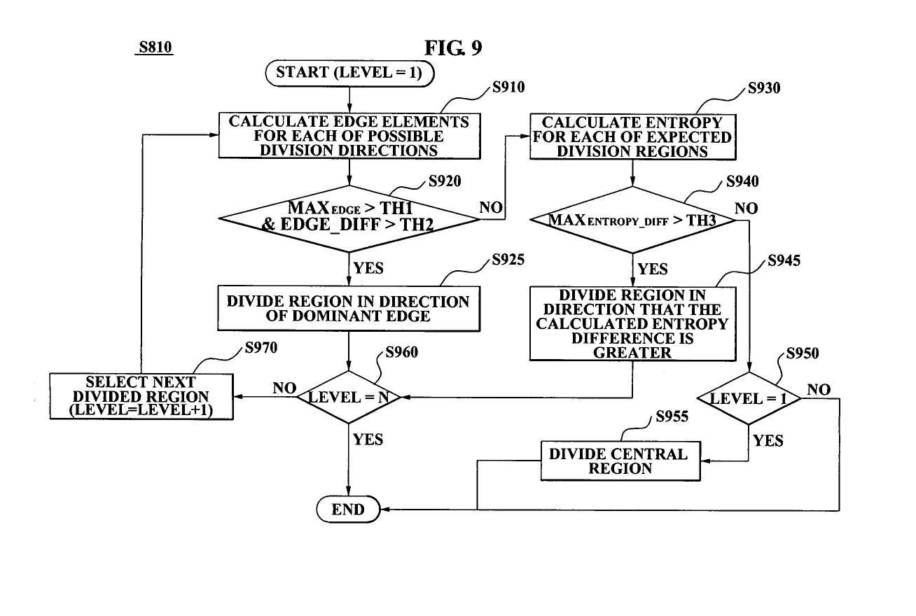

FIG. 8 is a flowchart of a photo category classification method according to another embodiment of the present invention. Referring to FIG. 8, in operation 810, the photo category classification system segments a region of an inputted photo based on content of the photo. Specifically, the photo category classification system analyzes the content of the inputted photo and adaptively segments the region of the photo based on the analyzed content of the photo. The photo category classification system calculates a dominant edge and an entropy differential and adaptively segments the region of the inputted photo based on the calculated dominant edge and entropy differential.

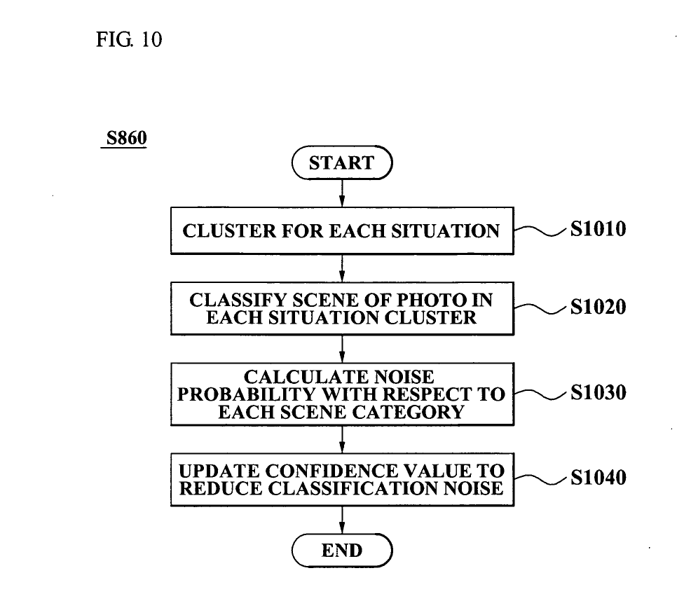

FIG. 9 is a flowchart of a process of adaptively dividing a region based on content of a photo (operation 810 of FIG. 8), according to an embodiment of the present invention. Referring to FIG. 9, the photo category classification system segments a region of a photo into N number of regions. A level of the photo before starting a region division operation is considered as 1.

In sub-operation 910, the photo category classification system calculates edge elements for each of possible division directions by analyzing content of the inputted photo. Specifically, the photo category classification system analyzes the content of the inputted photo and calculates an edge element for a horizontal direction or an edge element for a vertical direction when the possible division direction is the horizontal direction or the vertical direction.

In sub-operation 920, the photo category classification system determines whether a maximum edge element Max_{Edge} of the calculated edge elements is greater than a first threshold Th1 and whether a difference Edge_Diff of the calculated edge elements is greater than a second threshold Th2.

For example, when the calculated edge elements are a horizontal direction edge element and a vertical direction edge element and the horizontal direction edge element is greater than the vertical direction edge element, the photo category classification system determines whether the horizontal direction edge element is greater than the first threshold Th1, and whether a difference between the horizontal direction edge element and the vertical direction edge element is greater than the second threshold Th2.

Also, for example, when the calculated edge elements are a horizontal direction edge element and a vertical direction edge element, and the vertical direction edge element is greater than the horizontal direction edge element, the photo category classification system determines whether the vertical direction edge element is greater than the first threshold Th1 and whether a difference between the vertical direction edge element and the horizontal direction edge element is greater than the second threshold Th2.

When the maximum edge element Max_{Edge} is greater than the first threshold Th1 and the difference between the edge elements is greater than the second threshold Th2, in sub-operation S925, the photo category classification system segments the region of the photo in the direction of the dominant edge, which is a direction of the maximum edge element Max_{Edge}.

For example, when the maximum edge element Max_{Edge} is the horizontal direction edge element, the horizontal direction edge element is greater than the first threshold Th1, and the difference between the horizontal direction edge element and the vertical direction edge element is greater than the second threshold Th2, in sub-operation 925, the photo category classification system segments the region of the photo in the horizontal direction that is the direction of the dominant edge.

For example, when the maximum edge element Max_{Edge} is the vertical direction edge element, the vertical direction edge element is greater than the first threshold Th1, and the difference between the vertical direction edge element and the horizontal direction edge element is greater than the second threshold Th2, in sub-operation 925, the photo category classification system segments the region of the photo in the vertical direction that is the direction of the dominant edge.

Conversely, when the maximum edge element Max_{Edge} is equal to or less than the first threshold Th1 and/or the difference between the edge elements is equal to or less than the second threshold Th2, in sub-operation 930, the photo category classification system calculates entropy of expected division regions of the photo.

In sub-operation 940, the photo category classification system determines whether an maximum value of entropy differences Max_{Entropy}_{_{—}}_{Diff} for each of the expected division regions is greater than a third threshold Th3.

For example, when each of the expected division regions are expected to be segmented in the vertical direction and the horizontal direction as shown in FIG. 6, an entropy difference of the region segmented in the vertical direction is compared with an entropy difference of the region segmented in the horizontal direction. When the entropy difference of the vertical direction is greater than the entropy difference of the horizontal direction, in sub-operation 940, the photo category classification system considers the maximum value of the entropy differences Max_{Entropy}_{_{—}}_{Diff} of the expected division regions as the entropy difference of the vertical direction and determines whether the entropy difference of the vertical direction is greater than the third threshold Th3.

For example, when each of the expected division regions are expected to be segmented in the vertical direction and the horizontal direction as shown in FIG. 6, an entropy difference of the region segmented in the horizontal direction is compared with an entropy difference of the region segmented in the vertical direction. When the entropy difference of the horizontal direction is greater than the entropy difference of the vertical direction, in sub-operation 940, the photo category classification system considers the maximum value of the entropy differences Max_{Entropy}_{_{—}}_{Diff} of the expected division regions as the entropy difference of the horizontal direction and determines whether the entropy difference of the horizontal direction is greater than the third threshold Th3.

When the maximum value of the entropy differences Max_{Entropy}_{_{—}}_{Diff} of the expected division regions is greater than the third threshold Th3, in sub-operation 945, the photo category classification system segments the region of the photo in the direction where a difference between the calculated entropy values is the greatest.

When the maximum value of the entropy differences Max_{Entropy}_{_{—}}_{Diff} of the expected division regions is equal to or less than the third threshold Th3, in sub-operation 950, the photo category classification system determines whether a division level of the photo is 1. When the division level of the photo is not 1, the region of the photo is not segmented.

When the division level of the photo is 1, in sub-operation 955, the photo category classification system segments into the central region 571 and the peripheral region 572 of the photo 570 as shown in FIG. 5.

In sub-operation 960, the photo category classification system determines whether the division level of the photo is N. The N may be 3 when the photo category classification system tries to segment the region of the photo into 3.

When the division level of the photo is not N, in sub-operation 970, the photo category classification system selects a next segmented region by increasing the division level of the photo by 1 and performs the operations from sub-operation 910 again.

When the division level of the photo is N, in sub-operation 960, the division level of the photo is not 1, or after dividing the region of the photo into the central region 571 and the peripheral region 572, the photo category classification system finishes the operation of dividing the region of the photo based on the content of the photo.

As described above, according to the photo category classification method, the region of the photo is segmented by calculating the possible division direction edge elements of the photo by analyzing the content of the photo and calculating the entropy for each of the expected division regions of the photo, thereby reducing a number of the segmented regions compared to a conventional method of simply dividing the region of the photo into at least one region with a plurality of sub-regions without reflecting the content of the photo.

Referring to FIG. 8, in operation 820, the photo category classification system extracts a visual feature from the segmented region of the photo. Specifically, the photo category classification system extracts various visual features such as a color histogram, an edge histogram, a color structure, a color layout, and a homogeneous texture depicter, from the segmented region of the photo.

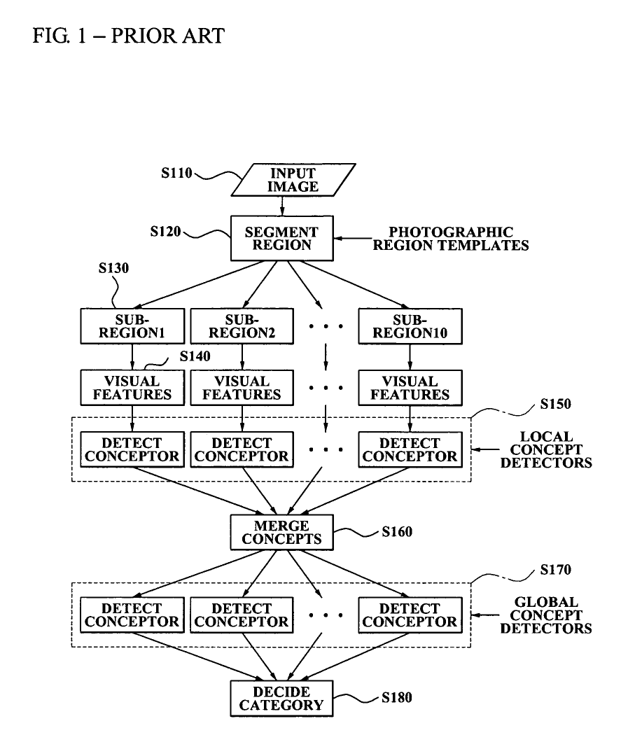

As described above, the photo category classification method may relatively reduce an amount of time for extracting the visual features from the number of the segmented regions due to a reduced number of the segmented regions shown in FIG. 5, rather than the conventional photo category classification method of extracting visual features from at least one region with 10 segmented sub-regions, as shown in FIGS. 1 and 2.

As described above, operations 810 and 820 are preprocessing operations for classifying the category of the photo in operations 830 through 850, which is a process of analyzing the content of the inputted photo, dividing the region of the photo based on the content of the photo, and extracting the visual feature form the segmented region of the photo.

In operation 830, the photo category classification system models local semantic concepts included in the photo according to the extracted visual feature. Specifically, to model each of the local semantic concepts, the photo category classification system extracts the visual features by previously preparing certain learning data, learns via the pattern learner such as SVM, and classifies local concepts via the pattern classifier, according to the extracted visual features.

In operation 840, the photo category classification system acquires a posterior probability value by normalizing via regression analysis with respect to confidence values acquired by local semantic concept modeling.

In operation 850, the photo category classification system models a global semantic concept included in the photo by using the posterior probability value for each of the local semantic concepts. Namely, to model the global semantic concept, the photo category classification system classifies global concept models previously learned via the pattern learner, from the pattern classifier.

In operation 860, the photo category classification system removes classification noise with respect to a confidence value acquired by the global semantic concept modeling. Specifically, the photo category classification system analyzes a plurality of photos, estimates a noise probability by using a fact that a probability that similar categories may exist in photos that are images sequentially photographed is high, and removes the classification noise by reflecting the estimated noise probability in the confidence value acquired by the global semantic concept modeling.

According to another embodiment of the present invention, operation 860, the photo category classification system estimates a probability of belonging to a category through probability modeling by analyzing metadata with respect to the photo and removes the classification noise by reflecting the estimated probability to the confidence value acquired by the global semantic concept modeling, as postprocessing operations for improving classification confidence with respect to the category of the inputted photo.

According to still another embodiment of the present invention, operation 860, the photo category classification system analyzes the confidence value acquired by the global semantic concept modeling and removes a category whose confidence value is low when confidence values with respect to mutually opposite categories exist.

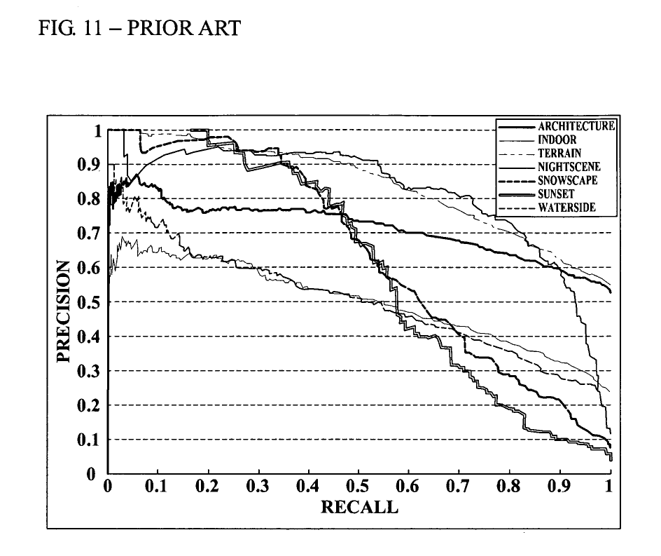

FIG. 10 is a flowchart of a process of removing noise by estimating noise probability function (operation 860 of FIG. 8), based on a histogram according to an embodiment of the present invention. Referring to FIG. 10, in operation 1010, the photo category classification system clusters the classified categories of the photo for each situation. Namely, to acquire a histogram of the photo, the photo category classification system clusters situation-based groups which are a group of photos similar with each other temporally or in image information.

In operation 1020, the photo category classification system classifies scenes in each situation cluster.

In operation 1030, the photo category classification system calculates a noise probability for each of the scene categories. Namely, when photos are images sequentially photographed in series of time, by one user, the photo category classification system estimates the noise probability with respect to each of the scene categories based on the fact that similar categories may exist in photos which are images sequentially photographed by the same user.

In operation 1040, the photo category classification system updates the confidence value of the photo to reduce the classification noise. Specifically, the photo category classification system updates the confidence value of the photo by reflecting the estimated noise probability in the confidence value of the photo.

Also, according to another embodiment of the present invention, in operation 1040, the photo category classification system may update the classification confidence value of the photo by estimating a probability of belonging to the category acquired by probability modeling Exif metadata included in the photo and removing the classification noise with respect to the confidence value of the photo based on the estimated probability.

Also, according to still another embodiment of the present invention, the photo category classification system may update the classification confidence value of the photo by filtering to remove the classification noise with respect to the classification confidence value of the photo by using a feature that categories of opposite concepts cannot exist simultaneously in one photo, as rule-based estimation method using correlation of a category group.

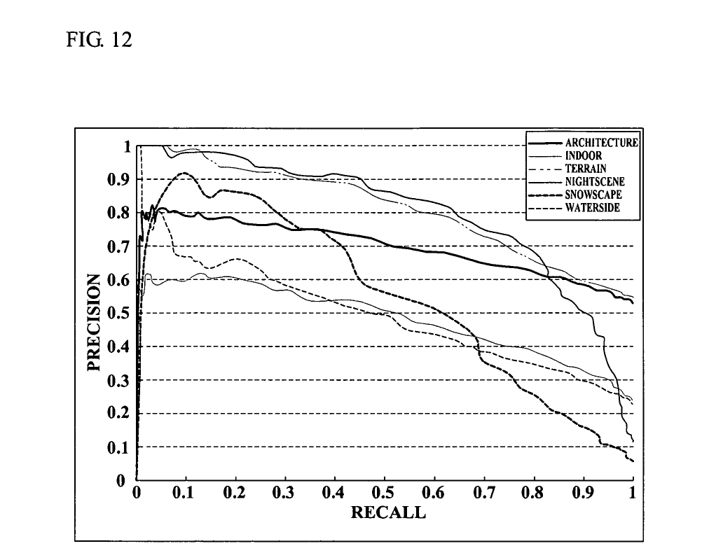

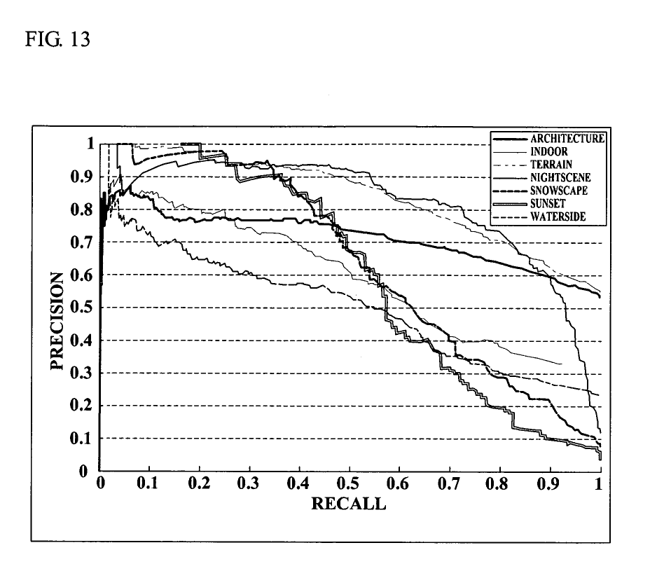

FIG. 11 is a diagram illustrating a result of a performance test of the conventional photo category classification method, FIG. 12 is a diagram illustrating a result of a performance test to which the preprocessing operation of dividing the region of the photo based on the content of the photo, of the photo category classification method according to an embodiment of the present invention, is applied, and FIG. 13 is a diagram illustrating a result of a performance test to which the preprocessing operation and the postprocessing operation of removing the classification noise, of the photo category classification method according to an embodiment of the present invention, is applied.

Comparing FIG. 11 with FIG. 12, when the preprocessing operation of the photo category classification method according to the present invention is applied, comparing with the conventional photo category classification method, there is little difference in performance of classifying the category of the photo but speed of classifying the category of the photo is improved more than four times because an amount of time used for classifying the category of the photo in the present invention is 0.85 second per page and an amount of time used for classifying the category of the photo in the conventional method is 4 seconds per page. Accordingly, the photo category classification system has a merit of excellent time savings in proportion to performance deterioration over the conventional photo category classification method.

Comparing FIG. 11 with FIG. 13, when the preprocessing operation and the postprocessing operation are all applied, an amount of time used for classifying the category of the photo is reduced as well as performance of classifying the category of the photo is improved, comparing with the conventional photo category classification method. Thus, according to the present invention, the classification speed and classification performance may be improved.

The photo category classification method according to the present invention may be embodied as a program instruction capable of being executed via various computer units and may be recorded in a computer-readable recording medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer-readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level language codes that may be executed by the computer using an interpreter.

An aspect of the present invention provides a photo category classification method and system capable of reducing an amount of time used for classifying a category of a photo while minimally deteriorating category classification performance.

An aspect of the present invention also provides a photo category classification method and system improving category classification precision through removing classification noise with respect to a result value passing a category classifier.

Although a few embodiments of the present invention have been shown and described, it would be appreciated by those skilled in the art that changes may be made to these embodiments without departing from the principles and spirit of the invention, the scope of which is defined in the claims and their equivalents.

What is claimed is:

1. A photo category classification method comprising:
segmenting a region of a photo based on content of the photo and extracting a visual feature from the segmented region of the photo;
modeling at least one local semantic concept included in the photo according to the extracted visual feature;
acquiring a posterior probability value from confidence values acquired from the modeling of the at least one local semantic concept by normalization using regression analysis;
modeling a global semantic concept included in the photo by using the posterior probability value of the at least one local semantic concept; and
removing classification noise from a confidence value acquired from the modeling the global semantic concept.

2. The method of claim 1, wherein the dividing a region of a photo based on content of the photo and extracting a visual feature from the segmented region of the photo comprises:
analyzing the content of the photo and adaptively dividing the region of the photo based on the analyzed content of the photo; and
extracting the visual feature from the segmented region of the photo.

3. The method of claim 2, wherein the analyzing the content of the photo and adaptively dividing the region of the photo based on the analyzed content of the photo comprises:
calculating edge elements for each possible division direction of the photo;
determining whether a maximum value of the calculated edge elements is greater than a first threshold and whether a difference between the calculated edge elements is greater than a second threshold; and
dividing the region of the photo in the edge direction of the maximum value when the maximum value is greater than the first threshold and the edge difference is greater than the second threshold.

4. The method of claim 3, further comprising:
calculating entropy for each expected division region of the photo when the maximum value of the calculated edge elements is equal to or less than the first threshold or the difference between the calculated edge elements is equal to or less than the second threshold;
determining whether a maximum value of a difference of the calculated entropies is greater than a third threshold; and
dividing the region of the photo in the direction where the calculated entropy difference is greatest, when the maximum value of the difference of the calculated entropies is greater than the third threshold.

5. The method of claim 4, further comprising:
determining whether the region of the photo is segmented, when the maximum value of the difference of the calculated entropies is equal to or less than the third threshold; and
dividing the photo according to a central region, when the region of the photo is not segmented.

6. The method of claim 1, wherein the removing of the classification noise comprises:
estimating a noise probability using a principal that a probability that similar categories exist when a plurality of images is sequentially photographed is high, by analyzing the plurality of photos; and
removing the classification noise by reflecting the estimated noise probability in the confidence value acquired through the modeling the global semantic concept.

7. The method of claim 1, wherein the removing of classification noise comprises:
estimating a probability of belonging to a category acquired through probability modeling by analyzing metadata of the photo; and
removing the classification noise by reflecting the estimated probability in the confidence value acquired by the modeling the global semantic concept.

8. The method of claim 1, wherein the removing of the classification noise comprises:
analyzing the confidence value acquired through the modeling of the global semantic concept; and
removing the category whose confidence value is lower than the others, when confidence values of mutually incompatible the categories exist.

9. A computer-readable recording medium in which a program for executing a photo category classification method is recorded, the method comprising:
dividing a region of a photo based on content of the photo and extracting a visual feature from the segmented region of the photo;
modeling at least one local semantic concept included in the photo according to extracted visual feature;
acquiring a posterior probability value from confidence values acquired from the modeling of the local semantic concept by normalization using regression analysis;
modeling a global semantic concept included in the photo by using the posterior probability value of each of the local semantic concepts; and
removing classification noise from a confidence value acquired from the modeling the global semantic concept.

10. A photo category classification system comprising:
a preprocessor performing preprocessing operations of analyzing content of an inputted photo, adaptively dividing a region of the photo based on the analyzed content of the photo, and extracting a visual feature from the segmented region of the photo;
a classifier classifying a category of the inputted photo depending on the visual feature extracted by the preprocessor; and
a postprocessor performing postprocessing operations of estimating classification noise of a confidence value of the category of the photo classified by the classifier and removing the estimated classification noise.

11. The system of claim 10, wherein the preprocessor comprises:
a region division unit analyzing the content of the inputted photo and adaptively dividing the region of the photo based on the analyzed content of the photo; and
a feature extraction unit extracting the visual feature from the segmented region of the photo.

12. The system of claim 11, wherein the region division unit calculates a dominant edge and entropy differential through analyzing the content of the inputted photo, and adaptively segments the region of the inputted photo based on the calculated dominant edge and entropy differential.

13. The system of claim 11, wherein the region division unit calculates edge elements for each possible division direction through analyzing the content of the inputted photo and segments the region of the photo in the direction of a dominant edge by comparing the calculated edge element with a threshold.

14. The system of claim 11, wherein the region division unit calculates entropy for each expected division region of the inputted photo, and segments the region of the photo in the direction where a difference between calculated entropy values is the greatest.

15. The system of claim 10, wherein the postprocessor estimates a noise probability through using a probability that similar categories exist when a plurality of images is sequentially photographed is high, through analyzing the plurality of photos, and removes the classification noise by reflecting the estimated noise probability in the confidence value acquired through the modeling the global semantic concept.

16. The system of claim 10, wherein the postprocessor estimates a probability of belonging to a category acquired through probability modeling by analyzing metadata of the photo, and removes the classification noise by reflecting the estimated probability in the confidence value acquired through the modeling of the global semantic concept, as postprocessing operations.

17. The system of claim 10, wherein the postprocessor analyzes the confidence value acquired through the modeling of the global semantic concept, and removes the category whose confidence value is low, when confidence values of mutually incompatible categories exist, as postprocessing operations.
